(19) United States
(12) Patent Application Publication
(10) Pub. No.: US 2005/0203788 A1
(43) Pub. Date: Sep. 15, 2005

(54) System and method for capacity management

(76) Inventors: Jen-Lin Chao, Hsinchu City (TW); Chen-Wei Hsu, Hsinchu City (TW); Wei-Chuan Huang, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/797,213

(22) Filed: Mar. 10, 2004

(51) Int. Cl. G06F 17/60

(52) U.S. Cl. 705/8

(57) ABSTRACT

A system and method for capacity management. The system includes at least an order management module and a pull-in engine. The order management module receives at least a first order having a period delivery demand directing a supplier to deliver products corresponding to the order before the end of the period. The pull-in engine pushes out the first order, and directs capacity reserved for the first order to meet a second order with a pull-in demand or if a production event occurs.

### BACKGROUND

The present invention relates to capacity management and particularly to a system and method for capacity management that manages orders according to respective client delivery demands.

In the supply of products, the supply chain performs the functions of material purchasing, transformation of materials into intermediate and finished products, and distribution of finished products to clients. Supply chain management has become important in meeting the goals of reduced inventory, increased productivity, and enhanced competitiveness. Manufacturing and distribution facilities have limited resources and capacity, hence, not every client request may be met, in that some may be promised but unfulfilled, some may receive inadequate supply, and others may be rejected. Consequently, effective management of capacity in supply chain management, without excess capacity loss, has become an important aspect for a product supplier who needs to control manufacture or distribution.

In the supply chain, clients transmit demands that may include a request for a particular quantity of a device design to a supplier by a specific date. The supplier plans its internal or external manufacturing schedule according to these received demands, and allocates capacity for manufacturing products to satisfy each client. After receiving orders corresponding to demands from clients, the supplier starts to manufacture the products.

In some specific situations, the clients may request a pull-in demand that asks the supplier to manufacture corresponding products as soon as possible. However, in the conventional capacity management model, all of the demands and orders are equally handled and the products are delivered based on a corresponding manufacturing planning schedule. If one order must be pulled-in, the manufacturing schedule and the allocated capacity for each client will be impacted. If the capacity of the supplier is full, orders of other clients may be pushed out unwillingly, thereby increasing client complaints. Additionally, the conventional capacity management model cannot maintain the quality of product delivery when difficulties occur in the production line.

### SUMMARY

The present invention is proposed to address the aforementioned issues. It is noted that the present invention is applicable to any factory, service supplier and product.

Accordingly, it is an object of the present invention to provide a system and method for capacity management according to respective client delivery demands.

To achieve the above object, the present invention provides a system and method for capacity management. According to one embodiment of the invention, the system includes at least an order management module and a pull-in engine. The order management module receives at least a first order having a period delivery demand directing a supplier to deliver products corresponding to the order before the end of the period. The pull-in engine pushes out the first order, and directs capacity reserved for the first order to meet a second order with a pull-in demand or if a production event occurs.

The system further includes an allocation module to allocate capacity for the pushed out order. The system further includes a planning module to generate a new manufacturing planning schedule and delivery dates for the first order and second order. Additionally, the first order further has a billing condition directing the supplier to generate a bill for the first order as late as possible.

According to another embodiment of the invention, the method for capacity management is provided. First, orders are identified based on respective corresponding delivery demand and/or billing conditions, thus identifying orders of a first type, in which the orders of the first type direct a supplier to deliver products before the end of a period. Then, at least one of the first type order is selected to be pushed out if another order with a pull-in demand is received or a production event occurs.

Further, additional capacity is allocated for the pushed out order, and a new manufacturing planning schedule and a delivery date for the pushed out order are generated.

The above-mentioned method may take the form of program code embodied in a tangible media. When the program code is loaded into and executed by a machine, the machine becomes an apparatus for practicing the invention.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the system architecture of the capacity management system according to an exemplary embodiment of the present invention;

FIG. 2 is a flowchart showing the process of order identification according to an exemplary embodiment of the present invention;

FIG. 3 is a flowchart showing the process of the capacity management for handling pull-in demand according to an exemplary embodiment of the present invention;

FIG. 4 is a flowchart showing the process of the capacity management for handling production difficulties according to an exemplary embodiment of the present invention; and

FIG. 5 is a schematic diagram illustrating a storage medium for storing a computer program for execution of the capacity management method according to an exemplary embodiment of the present invention.

### DESCRIPTION

The present invention provides a system and method overcoming conventional capacity management problems.

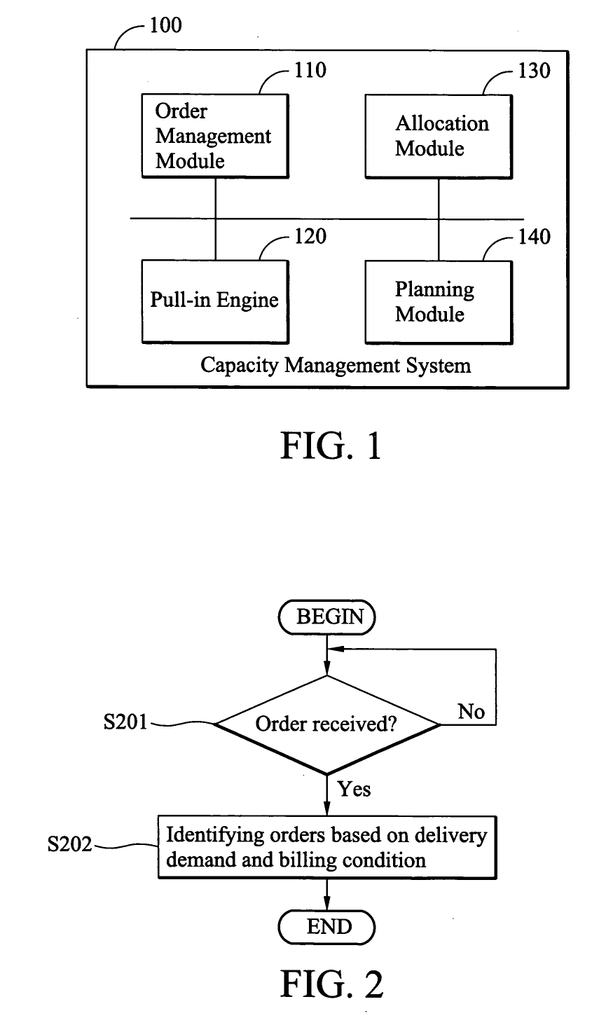

FIG. 1 illustrates the architecture of the capacity management system 100 according to an embodiment of the present invention. The capacity management system 100 includes an order management module 110, a pull-in engine 120, an allocation module 130 and a planning module 140.

The order management module 110 receives orders from clients, and identifies received orders into type A and type B based on corresponding delivery demands and billing conditions. Table 1 shows the scenario of type A and type B orders. Type A orders have a delivery demand directing the supplier to deliver corresponding products on schedule or as soon as possible, and a billing condition directing the supplier to generate bills for its order as soon as possible.

TABLE 1

| | Delivery demand | Billing Condition |
|---|---|---|
| Type A | On schedule/ASAP | ASAP |
| Type B | Delivery before the | ALAP |
| | end of the period | |

Type B orders have a delivery demand directing the supplier to deliver corresponding products before the end of a period, such as a manufacturing cycle, called period delivery demand, and a billing condition directing the supplier to generate bills for its order as late as possible. The order management module 110 identifies the type of order based on respective corresponding delivery demands and billing conditions. It is understood that the type A orders should be fulfilled with higher priority and type B orders may push out candidates when pull-in demands are received or a production difficulty arises, such as equipment malfunction, for example.

The pull-in engine 120 receives pull-in demands from clients, selects at least one of the candidates for push out, and directs the capacity reserved for the pushed out order to meet the order with pull-in demand. Additionally, when a production event occurs, the manufacturing planning schedule must be re-planned, and the pull-in engine 120 also selects a portion of the type B orders for push out, such that the released capacity can be used for orders with higher priority, thereby reducing impact on the manufacturing schedule.

The allocation module 130 allocates capacity for respective orders, and allocates another capacity in another manufacturing cycle for the pushed out order. The planning module 140 generates the manufacturing planning schedule for the received orders and the delivery dates for respective orders. Additionally, the planning module 140 further generates a new manufacturing planning schedule and new delivery dates for the pulled-in order and the pushed out order. After the pull-in operation, a production line (not shown) starts to manufacture the products to fulfill the orders of the current manufacturing cycle. When the products are manufactured, a delivery unit (not shown) delivers the products to corresponding clients, and a billing module (not shown) generates and transmits bills for respective orders to corresponding clients.

FIG. 2 shows the process of order identification according to an embodiment of the present invention. In step S201, it is determined whether orders have been received. If not, the flow returns to step S201. If yes, in step S202, the order management module 110 identifies the received order according to its delivery demand and billing condition, thus identifying the type of the order, and identifying the orders into type A and type B orders. It is understood that the capacity management system 100 may provide an interface for clients to transmit the order, and input the delivery demand and billing condition information of the order.

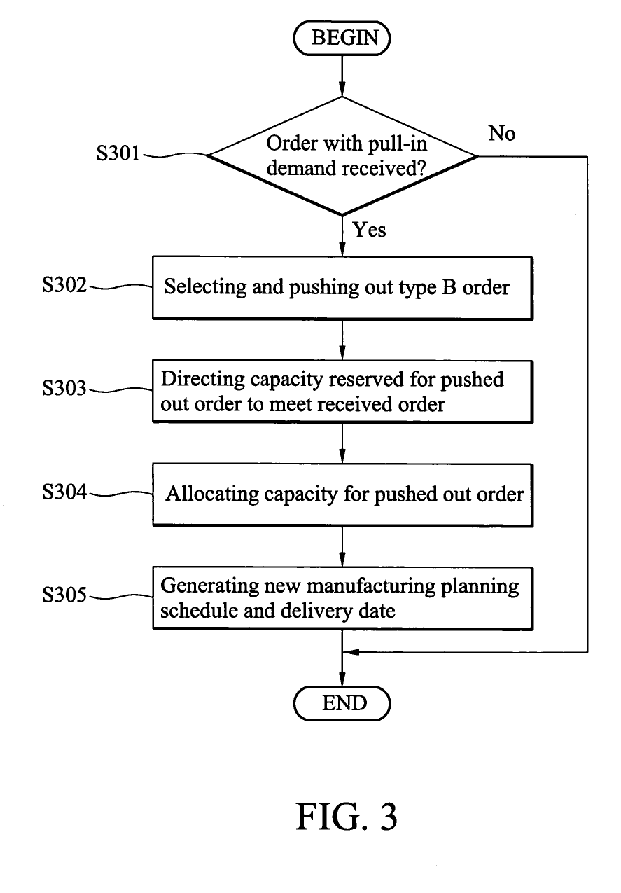

FIG. 3 shows the process of the capacity management method for handling pull-in demand according to an embodiment of the present invention.

In step S301, the pull-in engine 120 checks whether any order with pull-in demand has been received. If not, the process is complete. If an order with pull-in demand has been received (Yes in step S301), in step S302, the pull-in engine 120 selects at least one of the type B orders, and pushes it out. In step S303, the pull-in engine 120 directs the capacity reserved for the pushed out order to meet the order with pull-in demand. Thereafter, in step S304, the allocation module 130 allocates capacity in another manufacturing cycle for the pushed out order, and in step S305, the planning module 140 generates a new manufacturing planning schedule for the remaining orders and new delivery dates for the pulled-in order and the pushed out order.

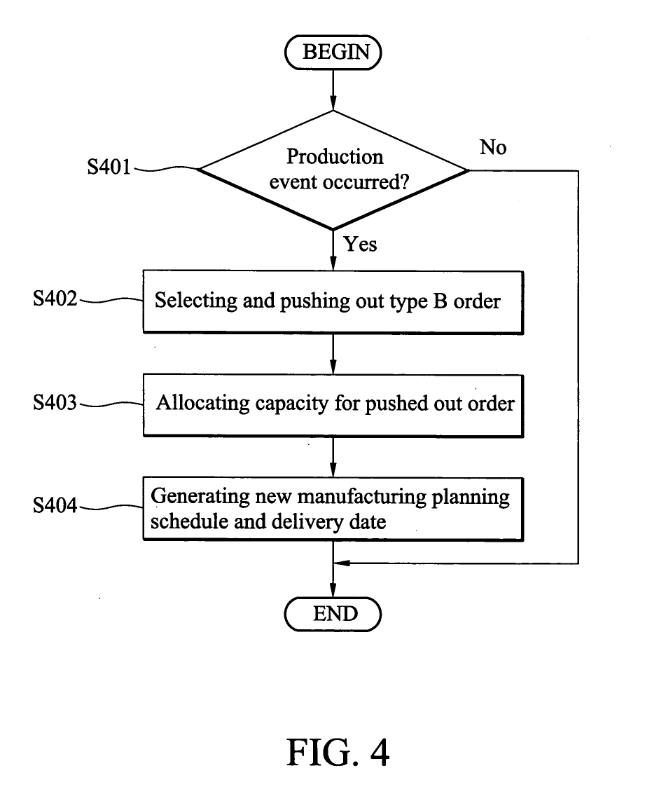

FIG. 4 shows the process of the capacity management method for handling production difficulties according to an embodiment of the present invention.

In step S401, it is determined whether or not any production difficulties have occurred. If not, the process is complete. If a production event occurs (Yes in step S401), in step S402, the pull-in engine 120 selects at least one of the type B orders, and pushes it out. It is noted that type A and type B orders are identified in advance. In step S403, the allocation module 130 allocates capacity in another manufacturing cycle for the pushed out order, and in step S404, the planning module 140 generates a new manufacturing planning schedule and new delivery dates for the orders.

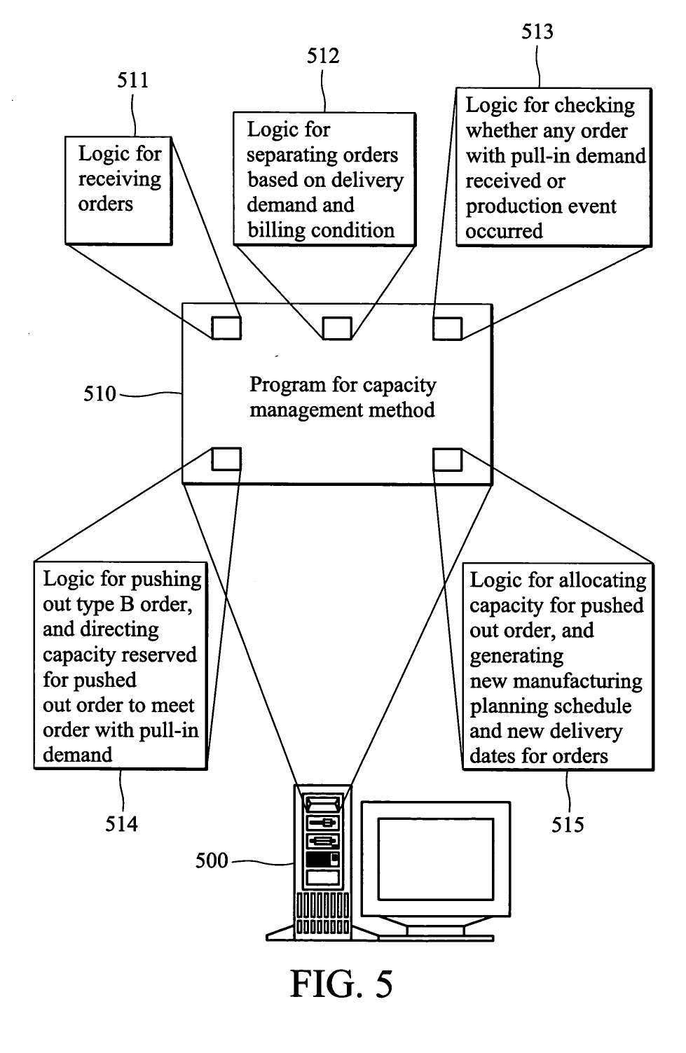

FIG. 5 is a diagram of a storage medium for storing a computer program providing the capacity management method according to an exemplary embodiment of the present invention. The computer program product comprises a storage medium 510 having computer readable program code embodied in the medium for use in a computer system 500, the computer readable program code comprises at least computer readable program code 511 receiving orders, computer readable program code 512 separating the orders based on respective delivery demand and billing condition, thus identifying the order type, in which type B orders have the period delivery demand and the ALAP billing condition, computer readable program code 513 checking whether any order with a pull-in demand has been received or a production event has occurred, computer readable program code 514 pushing out the type B order if an order with the pull-in demand has been received or the production event has occurred, and directing capacity reserved for the pushed out order to meet the order with pull-in demand, and computer readable program code 515 allocating capacity in another manufacturing cycle for the pushed out order, and generating a new manufacturing planning schedule and new delivery dates for the orders.

The present invention provides a capacity management mechanism dealing with problem of pull-in orders and production events more efficiently than in the prior art, thereby reducing client complaints, maintaining and improving the delivery and planning quality for each client, for example.

The exemplary embodiments of the methods and systems of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the invention. The methods and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its exemplary embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A system for capacity management, comprising:
an order management module to receive at least a first order having a period delivery demand directing a supplier to deliver products corresponding to the order before the end of the period; and
a pull-in engine to receive a second order with a pull-in demand, push out the first order, and direct capacity reserved for the first order to meet the second order.

2. The system of claim 1 further comprising an allocation module to allocate additional capacity for the first order.

3. The system of claim 2 further comprising a planning module to generate a new manufacturing planning schedule and delivery dates for the first order and second order.

4. The system of claim 1 wherein the first order further has a billing condition directing the supplier to generate a bill for the first order as late as possible.

5. A method for capacity management, comprising the steps of:
receiving at least a first order having a period delivery demand, in which the period delivery demand directs a supplier to deliver products corresponding to the order before the end of the period;
receiving a second order with a pull-in demand; and
pushing out the first order, and directing capacity reserved for the first order to meet the second order.

6. The method of claim 5 further comprising allocating additional capacity for the first order.

7. The method of claim 6 further comprising generating a new manufacturing planning schedule and delivery dates for the first order and second order.

8. The method of claim 5 wherein the first order further has a billing condition directing the supplier to generate a bill for the first order as late as possible.

9. A system for capacity management, comprising:
an order management module to receive at least a first order having a period delivery demand, in which the period delivery demand directs a supplier to deliver products corresponding to the order before the end of the period; and
a pull-in engine to push out the first order, and direct capacity reserved for the first order to meet other orders if a production event occurs.

10. The system of claim 9 further comprising an allocation module to allocate additional capacity for the first order.

11. The system of claim 10 further comprising a planning module to generate a new manufacturing planning schedule and a delivery date for the first order.

12. The system of claim 9 wherein the first order further has a billing condition directing the supplier to generate a bill for the first order as late as possible.

13. A method for capacity management, comprising the steps of:
receiving at least a first order having a period delivery demand, in which the period delivery demand directs a supplier to deliver products corresponding to the order before the end of the period; and
pushing out the first order, and directing capacity reserved for the first order to meet another order if a production event occurs.

14. The method of claim 13 further comprising allocating another capacity for the first order.

15. The method of claim 14 further comprising generating a new manufacturing planning schedule and a delivery date for the first order.

16. The method of claim 13 wherein the first order further has a billing condition directing the supplier to generate a bill for the first order as late as possible.

17. A method for capacity management, comprising the steps of:
separating orders based on respective corresponding delivery demand, thus identifying orders of a first type, in which orders of the first type direct a supplier to deliver products before the end of a period; and
selecting at least one of the orders of the first type to be pushed out if another order with a pull-in demand is received or a production event occurs.

18. The method of claim 17 further comprising allocating additional capacity for the pushed out order.

19. The method of claim 18 further comprising generating a new manufacturing planning schedule and a delivery date for the pushed out order.

20. The method of claim 13 further comprising separating the orders based on a respective corresponding billing condition directing the supplier to generate a bill for the first order as late as possible.

21. A machine-readable storage medium storing a computer program which when executed causes a computer to perform a capacity management method, the method comprising the steps of:
receiving at least a first order having a period delivery demand, in which the period delivery demand directs a supplier to deliver products corresponding to the order before the end of the period;
receiving a second order with a pull-in demand; and
pushing out the first order, and directing capacity reserved for the first order to meet the second order.

22. The storage medium of claim 21 wherein the method further comprises a step of allocating additional capacity for the first order.

23. The storage medium of claim 22 wherein the method further comprises a step of generating a new manufacturing planning schedule and delivery dates for the first order and second order.

24. The storage medium of claim 21 wherein the first order further has a billing condition directing the supplier to generate a bill for the first order as late as possible.

25. A machine-readable storage medium storing a computer program which when executed causes a computer to perform a capacity management method, the method comprising the steps of:
receiving at least a first order having a period delivery demand, in which the period delivery demand directs a supplier to deliver products corresponding to the order before the end of the period; and
pushing out the first order, and directing capacity reserved for the first order to meet other order if a production event occurs.

26. The storage medium of claim 25 wherein the method further comprises a step of allocating additional capacity for the first order.

27. The storage medium of claim 26 wherein the method further comprises a step of generating a new manufacturing planning schedule and a delivery date for the first order.

28. The storage medium of claim 25 wherein the first order further has a billing condition directing the supplier to generate a bill for the first order as late as possible.

29. A machine-readable storage medium storing a computer program which when executed causes a computer to perform a capacity management method, the method comprising the steps of:
separating orders based on respective corresponding delivery demands, thus identifying orders of a first type, in which the orders of the first type indicate a supplier to deliver products before the end of a period; and
selecting at least one of the orders of the first type to be pushed out if another order with a pull-in demand is received or a production event occurs.

30. The storage medium of claim 29 wherein the method further comprises a step of allocating additional capacity for the pushed out order.

31. The storage medium of claim 30 wherein the method further comprises a step of generating a new manufacturing planning schedule and a delivery date for the pushed out order.

32. The storage medium of claim 29 wherein the method further comprises a step of separating the orders based on a respective corresponding billing condition directing the supplier to generate a bill for the first order as late as possible.
